(19) United States
(12) Patent Application Publication
(10) Pub. No.: US 2023/0323066 A1
(43) Pub. Date: Oct. 12, 2023

(54) RESINOUS MEMBRANE AND WATER-RESISTANT AND MOISTURE-PERMEABLE MEMBRANE

(71) Applicant: CANON KABUSHIKI KAISHA, Tokyo (JP)

(72) Inventors: YUSUKE BABA, Kanagawa (JP); MASAAKI TAKAHASHI, Kanagawa (JP); YOHEI MIYAUCHI, Tokyo (JP); NAOKO KASAI, Kanagawa (JP)

(21) Appl. No.: 18/336,150

(22) Filed: Jun. 16, 2023

Related U.S. Application Data
(63) Continuation of application No. PCT/JP2021/046737, filed on Dec. 17, 2021.

(30) Foreign Application Priority Data
Dec. 25, 2020 (JP) 2020-217954
Nov. 12, 2021 (JP) 2021-184835

(51) Int. Cl. C08J 9/26; C08J 5/18

(52) U.S. Cl. CPC C08J 9/26; C08J 5/18; C08J 2327/18

(57) ABSTRACT

A resinous membrane comprising a resin including a tetrafluoroethylene-perfluoroalkyl vinyl ether copolymer, having a water pressure resistance of 800 kPa or more, and having a moisture permeability of 1500 g/m²·day or more.

### CROSS-REFERENCE TO RELATED APPLICATION

This is a continuation of International Application No. PCT/JP2021/046737, filed on Dec. 17, 2021, and designated the U.S., and claims priority from Japanese Patent Application No. 2020-217954 filed on Dec. 25, 2020, and Japanese Patent Application No. 2021-184835 filed on Nov. 12, 2021, the entire contents of which is incorporated herein by reference.

### BACKGROUND OF THE INVENTION

### Field of the Invention

The present disclosure relates to a resinous membrane and a water-resistant and moisture-permeable membrane that have excellent water resistance and moisture permeability and can be used as clothing materials such as waterproof clothing and sports clothing.

### Background Art

A water-resistant and moisture-permeable membrane containing a fluororesin commercially available as “GORE-TEX” (registered trademark) is composed of an expanded polytetrafluoroethylene membrane (hereinafter also referred to as “ePTFE membrane”).

For example, “POREFLON FP-010-60” (trade name (POREFLON is a registered trademark)), which is an ePTFE membrane manufactured by Sumitomo Electric Fine Polymer, Inc., has a thickness of 60 μm, a moisture permeability (Japanese Industrial Standard (hereinafter referred to as “JIS”) Z 0208:1976) of 9415 g/m² day, and a water pressure resistance of 375 kPa. In addition, “POREFLON FP-045-80” (trade name), which is an ePTFE membrane manufactured by Sumitomo Electric Fine Polymer, Inc., has a thickness of 80 μm, a moisture permeability (JIS Z 0208) of 10438 g/m² day, and a water pressure resistance of 200 kPa.

### CITATION LIST

### Patent Literature

PTL 1 Japanese Patent Application Publication NO. 2019-192749
PTL 2 WO 2018/116517
PTL 3 Japanese Patent Application Publication NO. 2006-305937
PTL 4 Japanese Patent Application Publication NO. H9-255807

### Non Patent Literature

NPL 1 IEEE Transactions on Image Processing, Vol. 4, Issue: 3, March 1995, pp. 370-378.
NPL 2 IEEE Transactions on Systems, Man, and Cybernetics, Vol. SMC-9, No. 1, January 1979, pp. 62-66.

According to the studies of the present inventors, commercially available ePTFE membranes still have room for improvement. Specifically, the moisture permeability and water pressure resistance of water-resistant and moisture-permeable membranes are in a contradictory relationship, and although the ePTFE membrane according to PTL 1 has a very high water pressure resistance of 800 kPa or more, the achieved moisture permeability is 500 g/m² day or less.

Although the ePTFE membrane according to PTL 2 has a very high moisture permeability of 13,000 g/m² day, the achieved water pressure resistance is at an extremely low level of 25 kPa. PTL 3 describes a composite material in which an elastic sheet is laminated on an ePTFE membrane, but although the moisture permeability is high, the achieved water pressure resistance is still insufficient at 450 kPa. Further, PTL 4 describes a PFA porous membrane made of a tetrafluoroethylene-perfluoroalkyl vinyl ether copolymer (hereinafter also referred to as “PFA”), but the pore size is large and it is not a water-resistant and moisture-permeable membrane which has a sufficient water pressure resistance.

### SUMMARY OF THE INVENTION

At least one aspect of the present disclosure is directed to providing a resinous membrane capable of achieving both high moisture permeability and high water pressure resistance at high levels. Further, another aspect of the present disclosure is aimed at providing a water-resistant and moisture-permeable membrane capable of achieving both high moisture permeability and high water pressure resistance at high levels.

According to at least one aspect of the present disclosure, there is provided a resinous membrane comprising a resin, containing a tetrafluoroethylene-perfluoroalkyl vinyl ether copolymer. The resinous membrane has a water pressure resistance of 800 kPa or more, and has a moisture permeability of 1500 g/m²·day or more.

According to another aspect of the present disclosure, there is provided a resinous membrane comprising a resin including a tetrafluoroethylene-perfluoroalkyl vinyl ether copolymer. The resinous membrane has pores open to a first surface and communicating with a second surface on an opposite side to the first surface, and when a first observation area of 8 μm length and 11 μm width is put on the first surface and a ratio of a total area of an opening observed in the first observation area to an area of the first observation area is denoted by P1, and a second observation area of 8 μm length and 11 μm width is put on a cross section of the resinous membrane in a thickness direction and a ratio of a total area of the pores observed in the second observation area to an area of the second observation area is denoted by P2,
1.3<(P2/P1) is satisfied.

According to another aspect of the present disclosure, there is provided a water-resistant and moisture-permeable membrane comprising the above resinous membrane.

Further features of the present disclosure will become apparent from the following description of exemplary embodiments with reference to the attached drawings.

### BRIEF DESCRIPTION OF THE DRAWINGS

FIG. 1 is a schematic cross-sectional view of a resinous membrane.

FIG. 2A is a schematic surface view of a resinous membrane of an Example, and a FIG. 2B is a schematic cross-sectional view observed in the thickness direction.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined.

The resinous membrane according to the present disclosure comprises a resin, and a tetrafluoroethylene-perfluoroalkyl vinyl ether copolymer (hereinafter also referred to as “PFA”) making it possible to obtain a flexible resinous membrane is comprised as the resin. The resinous membrane has a water pressure resistance of 800 kPa or more, preferably 840 kPa or more. Although the upper limit is not particularly limited, it is preferably 1500 kPa or less, more preferably 1250 kPa or less. Also, the resinous membrane has a moisture permeability of 1500 g/m²·day or more, preferably 1800 g/m²·day or more. Although the upper limit is not particularly limited, it is preferably 8,000 g/m²·day or less, and more preferably 5500 g/m²·day or less. More specifically, the resinous membrane according to the present disclosure has a water pressure resistance of preferably from 800 kPa to 1500 kPa, more preferably from 840 kPa to 1250 kPa, and a moisture permeability of preferably from 1500 g/m²·day to 8000 g/m²·day, more preferably from 1800 g/m²·day to 5500 g/m²·day.

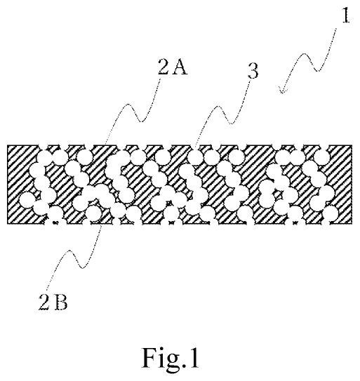

A resinous membrane according to one aspect of the present disclosure, which can achieve both high water pressure resistance and high moisture permeability, will be described below with reference to FIG. 1. The present disclosure is not limited to this embodiment.

The resinous membrane 1 has pores 3 inside the membrane between one surface 2A (hereinafter also referred to as “first surface”) and a surface 2B opposite to the first surface (hereinafter also referred to as “second surface”). The pores 3 open to the first surface, connected to the second surface, and open to the second surface as well.

Where a rectangular first observation area of 8 μm length and 11 μm width is put on the first surface and the ratio of the total area of the openings observed in the first observation area to the area of the first observation area is denoted by P1, and where a rectangular second observation area of 8 μm length and 11 μm width is put on the cross section of the resinous membrane in the thickness direction and the ratio of the total area of the pores observed in the second observation area to the area of the second observation area is denoted by P2, it is preferable that 1.3≤(P2/P1), particularly 1.7≤(P2/P1), and further 5.0≤(P2/P1) be satisfied.

Although the upper limit of P2/P1 is not particularly limited, it is preferably 20.0 or less, more preferably 15.0 or less, and even more preferably 10.0 or less. More specifically, P2/P1 is preferably from 1.3 to 20.0, more preferably from 1.7 to 15.0, and particularly preferably from 5.0 to 10.0.

By setting P1 and P2 in the above relationship, even when the opening diameter of the pores on the first surface is made small enough to prevent water from entering from the first surface, since there are many pores inside the resinous membrane, penetration of water vapor into the resinous membrane from the second surface side into the resinous membrane is not inhibited. Also, the water vapor in the pores can be released from the openings in the first surface. Therefore, the resinous membrane can achieve both high water pressure resistance and high moisture permeability.

P1 is calculated by the following method. One surface of the resinous membrane is observed with a scanning electron microscope to obtain an SEM image (magnification: 10,000) of an observation area of 8 μm length and 11 μm width on the first surface. The resolution is such that individual openings can be recognized (for example, 717 pixels vertically and 986 pixels horizontally).

The SEM image is converted to an 8-bit grayscale image using image processing software (trade name: Image-J, manufactured by the National Institutes of Health (NIH), USA). After applying a median filter to the obtained grayscale image, binarization processing is further performed using the above image processing software to obtain a binarized image. The binarization process uses the Yen's method described in NPL 1 to discriminate between a portion corresponding to the opening and a portion corresponding to the PFA in the SEM image.

Then, the ratio of the number of pixels in the portion corresponding to the opening in the obtained binarized image to the number of pixels in the entire image is calculated. In the present disclosure, the observation areas are set at arbitrary 10 locations on the first surface of the resinous membrane, and the arithmetic average value of the ratios calculated from each observation area is defined as P1. The 10 observation areas are set to positions such that the observation areas do not overlap each other. A specific method will be described in Examples described hereinbelow.

P2 is calculated by the following method. A sample is cut out from the resinous membrane so that a cross section including the entire thickness of the resinous membrane appears. A predetermined position in the cross section of the cut sample is observed with a scanning electron microscope to obtain an SEM image of an observation area of 8 μm length and 11 μm width on the cross section. The resolution is such that the pores appearing in the cross section can be recognized (for example, 717 pixels vertically and 986 pixels horizontally).

The SEM image is binarized using numerical calculation software (trade name: MATLAB; manufactured by The MathWorks, Inc.) to obtain a binarized image. The binarization process uses the Otsu's method described in NPL 2 to discriminate between a portion corresponding to the opening and a portion corresponding to the PFA in the SEM image. Then, the ratio of the number of pixels corresponding to the pores in the binarized image to the number of pixels in the entire image is calculated. In the present disclosure, the acquisition positions of the SEM image are set as follows with respect to the thickness direction of the resinous membrane in the cross section.

(1) A position where 1 μm from the first surface side to the second surface side of the cross section is the upper end of the observation area, and the upper end of the observation area is parallel to the first surface.

(2) A position where the midpoint between the first surface and the second surface of the cross section coincides with the center of gravity of the observation area, and one side of the observation area is parallel to the first surface.

(3) A position where 1 μm from the second surface to the first surface is the lower end of the observation area, and the lower end of the observation area is parallel to the second surface.

These three acquisition positions at the cross section that are set in the thickness direction are provided in the circumferential direction of a fixing rotating member, for a total of nine positions. The arithmetic mean value of the ratios calculated from each of the nine observation areas is defined as P2. Specifics will be explained in the examples described hereinbelow.

In order to prevent water from entering the resinous membrane from the first surface and impart high water pressure resistance to the resinous membrane, it is preferable that P1 calculated by the above method be 15.0% or less, particularly 120% or less. Meanwhile, in order to effectively release the water vapor, which has entered the pores of the resinous membrane from the second surface, from the first surface side, P1 is preferably 1.0% or more, particularly 1.5% or more, furthermore 3.0% or more. Specifically, P1 is preferably from 1.0% to 15.0%, more preferably from 1.5% to 12.0% or less, particularly preferably from 3.0% to 15.0%.

Also, P2 is preferably 20.0% or more, more preferably 25.0% or more. By setting P2 to 20.0% or more, passage paths of water vapor in the resinous membrane can be increased, and moisture permeability can be improved. Although the upper limit of P2 is not particularly limited, it is preferably 60.0% or less, more preferably 50.0% or less, from the viewpoint of more reliably maintaining the strength of the resinous membrane. Specifically, P2 is preferably from 20.0% to 60.0%, more preferably from 25.0% to 50.0%.

The average opening diameter of the openings on the first surface of the resinous membrane is preferably from 1 nm to 200 nm, more preferably from 50 nm to 140 nm. When the average opening diameter is 1 nm or more, diffusion paths of water vapor on the surface are enlarged, so that moisture permeability is likely to be improved. In addition, where the average opening diameter is 200 nm or less, water permeation from the first surface into the inside of the resinous membrane can be further suppressed, which contributes to the improvement of water pressure resistance of the resinous membrane. The average opening diameter of the openings on the first surface is the average value of the diameters of circles having the same area as the portion corresponding to the opening from the binarized image used to calculate P1 described above. A specific method will be described hereinbelow.

The resinous membrane is preferably a single-layer membrane. The resinous membrane can be used as a water-resistant and moisture-permeable membrane. That is, it is preferable that a water-resistant and moisture-permeable membrane have the resinous membrane. The water-resistant and moisture-permeable membrane may be composed only of the resinous membrane and may be configured by laminating another resinous membrane or fiber membrane on at least one of the first surface side and the second surface side of the resinous membrane.

The thickness of the resinous membrane is not particularly limited, but is preferably 12 μm or more, more preferably 15 μm or more, preferably 100 μm or less, more preferably 50 μm or less, and particularly preferably 40 μm or less. Specifically, the thickness of the resinous membrane is preferably from 12 μm to 100 μm, more preferably from 15 μm to 50 μm, and particularly preferably from 15 μm to 40 μm.

<PFA>

The PFA comprised in the resinous membrane is a copolymer of a perfluoroalkyl vinyl ether (hereinafter referred to as “PAVE”) and tetrafluoroethylene (hereinafter referred to as “TFE”). The perfluoroalkyl chain in PAVE preferably has 1 to 6 carbon atoms, more preferably 1 to 4 carbon atoms, and still more preferably 1 to 3 carbon atoms.

The PAVE is preferably selected from perfluoromethyl vinyl ether (CF₂═CF—O—CF₃), perfluoroethyl vinyl ether (CF₂═CF—O—CF₂CF₃) and perfluoropropyl vinyl ether (CF₂═CF—O—CF₂CF₂CF₃).

The melting point of PFA is preferably 280° C. to 320° C., more preferably 290° C. to 310° C.

Commercially available products can be used as PFA, and specific examples thereof are given below.
“451HP-J”, “959HP-Plus”, “350-J”, and “950HP-Plus” (all trade names, manufactured by Mitsui Chemours Fluoro Products Co., Ltd.);
“α-66P”, “P-66PT”, and “P-802UP” (all trade names, manufactured by AGC Inc.);
“AP-230”, “AP-231SH”, etc. (all trade names, manufactured by Daikin Industries, Ltd.);
“6502N” (trade name, manufactured by 3M Co.).

<Method for Manufacturing Resinous Membrane>

Examples of non-limiting methods for manufacturing the resinous membrane according to one aspect of the present disclosure include a method including the following steps (i) to (v).
(i) A step of preparing a resinous membrane comprising PFA (hereinafter also referred to as “non-impregnated resinous membrane”);
(ii) a step of masking the surface on one side of the non-impregnated resinous membrane (hereinafter also referred to as “first surface”);
(iii) a step of bringing perfluoropolyether (PFPE) heated to a temperature near the melting point of PFA into contact with the surface (hereinafter also referred to as “second surface”) on the other side of the non-impregnated resinous membrane obtained in step (ii), in which the first surface was masked, and impregnating the non-impregnated resinous membrane with PFPE from the second surface to obtain a resinous membrane impregnated with PFPE (hereinafter also referred to as “impregnated resinous membrane”);
(iv) a step of cooling the impregnated resinous membrane to near room temperature (for example, 20° C. to 35° C., preferably 25° C. to 30° C.); and
(v) a step of removing at least part of the PFPE in the impregnated resinous membrane that has been cooled to near room temperature through step (iv) from the second surface side of the impregnated resinous membrane and forming pores that open to the second surface and connected to the first surface (also pores that open to the first surface and connected to the second surface) to obtain the resinous membrane according to the present disclosure.

The inventors presume that the resinous membrane according to one aspect of the present disclosure can be formed by the above method for the following reason.

In step (iii), one surface of the non-impregnated resinous membrane is brought into contact with PFPE at a temperature near the melting point of PFA comprised in the non-impregnated resinous membrane (temperature of 300° C.±50° C. (preferably 290° C. to 325° C.) to impregnate PFPE into the non-impregnated resinous membrane and obtain the impregnated resinous membrane.

In step (iii), the resinous membrane impregnated with PFPE is in a high temperature state, so following step (iii), in step (iv), the impregnated resinous membrane is cooled to room temperature, for example, near 25° C. Next, in step (v), the PFPE in the impregnated resinous membrane is removed using a solvent, thereby forming pores that are open to the second surface of the resinous membrane at the sites where PFPE was present in the impregnated resinous membrane.

In the resinous membrane formed through the above steps (iv) to (v), the area ratio P2 of pores per unit area (8 μm×11 μm) in the cross section in the thickness direction thereof is larger than the area ratio P1 of openings per unit area (8 μm×11 μm) in the second surface. This is because the impregnated resinous membrane, which has expanded due to the high temperature in step (iii), shrinks due to the cooling in step (iv), but since cooling progresses more rapidly on the second surface side of the impregnated resinous membrane than on the first surface side, the degree of shrinkage on the second surface side is larger. As the second surface side of the impregnated resinous membrane shrinks, the PFPE present in the vicinity of the second surface of the impregnated resinous membrane is pushed out of the impregnated resinous membrane from the second surface. As a result, the diameter of the opening on the second surface of the resinous membrane is reduced.

Meanwhile, since the first surface of the impregnated resinous membrane is masked, the PFPE that has penetrated to the first surface side of the impregnated resinous membrane is not released outside the impregnated resinous membrane and stays inside the impregnated resinous membrane even when the impregnated resinous membrane shrinks. Therefore, the size of the PFPE agglomerates that become voids after the removal of PFPE is hardly reduced. As a result, the ratio (P2/P1) of the porosity P2 to the opening ratio P1 on the one surface of the resinous membrane formed resulting from the step (v) increases.

Here, the value of P2/P1 can be adjusted by the amount of PFPE impregnated into the non-impregnated resinous membrane in the impregnation step (iii). That is, by increasing the amount of PFPE impregnated into the non-impregnated resinous membrane, voids inside the resinous membrane can be increased, and the value of P2 increases. Moreover, by increasing the amount of impregnation into the non-impregnated resinous membrane, the number of openings on the second surface of the resinous membrane also increases, so the value of P1 increases. However, although the reason is not clear, the degree of increase in P1 due to the increase in the impregnation amount into the non-impregnated resinous membrane is greater than the degree of increase in P2. Therefore, by increasing the amount of PFPE impregnated into the non-impregnated resinous membrane, P2/P1 can be adjusted to be smaller.

The amount of PFPE impregnated into the non-impregnated resinous membrane can be adjusted, for example, by the temperature of PFPE during impregnation, the viscosity of PFPE, and the contact time between the non-impregnated resinous membrane and PFPE. Specifically, the amount of PFPE impregnated into the non-impregnated resinous membrane can be increased by increasing the temperature within the range near the melting point of PFA (250° C. to 350° C.), lowering the viscosity of PFPE, and extending the contact time.

In order to achieve the preferable range of P2 described above, in step (iii), it is preferable to impregnate PFPE in step (iii) so that the content ratio of PFPE is preferably 25% by mass to 60% by mass, particularly 30% by mass to 45% by mass, based on the mass of the impregnated resinous membrane.

The temperature of PFPE in step (iii) is preferably 250° C. to 350° C., particularly 290° C. to 325° C., because the melting point (Tm) of PFA is in the range of 280° C. to 320° C.

The contact time between the outer peripheral surface of the non-impregnated resinous membrane and PFPE varies depending on the viscosity and amount of PFPE to be impregnated into the non-impregnated resinous membrane, but as a guideline, the contact time is 20 sec to 5 min, particularly 30 sec to 2 min. Over the time within this range, an amount of PFPE sufficient to form voids in the resinous membrane can be impregnated.

Furthermore, the lower the viscosity of PFPE, the greater the amount of impregnation into the non-impregnated resinous membrane. However, PFPE with too low a viscosity may not easily form a PFPE region by agglomeration and linkage in the resin tube, possibly due to the increased affinity with PFA, and it may be difficult to obtain a high pore area ratio. Therefore, the preferable viscosity of PFPE to be impregnated in the non-impregnated resinous membrane is 10 mPa·s to 400 mPa·s, particularly 30 mPa s to 350 mPa·s.

The viscosity referred to herein is a value measured using a rheometer (manufactured by TA Instruments: DHR-2) after mounting a cone plate mold with a cone angle of 1° and a cone radius of 20 mm and rotating at a shear rate of 100 s⁻¹ for 60 sec. The measurement temperature is set to 40° C.

The perfluoropolyether preferably includes PFPE having a structure represented by the following formula (1). PFPE is preferably one that becomes oily at the melting point of PFA.

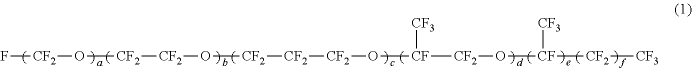

In formula (1), a, b, c, d, e, and f are each independently 0 or a positive integer, satisfy 1≤a+b+c+d+e+f≤600, and at least one of a, b, c, and d is a positive integer.

In addition, the order of presence of each repeating unit in formula (1) is not limited to the order described above. Furthermore, each repeating unit in formula (1) may be present at multiple locations in PFPE. That is, the PFPE represented by Formula (1) may be a block copolymer or a random copolymer.

Specifically, the perfluoropolyether preferably has at least one structure selected from the group consisting of the following formulas (2) to (5).

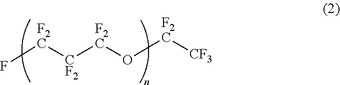

(In formula (2), n is a positive number, and n is a number in the range in which the viscosity of PFPE at a temperature of 40° C. is within a range of 30 mPa·s to 400 mPa·s).

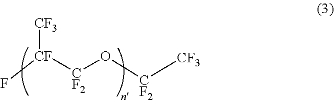

(In formula (3), n′ is a positive number, and n′ is a number in the range in which the viscosity of PFPE at a temperature of 40° C. is within a range of 10 mPa·s to 400 mPa·s).

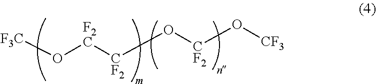

(In formula (4), n″ and m are each independently a positive number, m/n″ is a number that is from 0.5 to 2, and n″+m is a number in the range in which the viscosity of PFPE at a temperature of 40° C. is within a range of 20 mPa s to 400 mPa s).

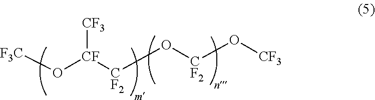

(In formula (5), n′″ and m′ are each independently a positive number, m′/n′″ is a number that is from 0.5 to 2, and n′″+m′ is a number in the range in which the viscosity of PFPE at a temperature of 40° C. is within a range of 20 mPa s to 400 mPa s).

Examples of commercially available PFPE with the viscosity in the above preferred range include PFPE having a structure represented by formula (2) (for example, DEMNUM S-200 and DEMNUM S-65 (both trade names); manufactured by Daikin Industries, Ltd.), PFPE having a structure represented by formula (3) (for example, KRYTOX GPL-105, KRYTOX GPL-104, KRYTOX GPL-103, KRYTOX GPL-102, and KRYTOX GPL-101 (all trade names); manufactured by The Chemours Company), PFPE having a structure represented by formula (4) (for example, FOMBLIN M07 and FOMBLIN M15 (both trade names); manufactured by Solvay Specialty Polymers), and PFPE represented by formula (5) (for example, FOMBLIN Y15 and FOMBLIN Y25 (both trade names); manufactured by Solvay Specialty Polymers).

For example, “DEMNUM S-200” has a viscosity of 377 mPa s, “KRYTOX GPL-105” has a viscosity of 301 mPa·s, “KRYTOX GPL-104” has a viscosity of 111 mPa s, and “KRYTOX GPL-103” has a viscosity of 54 mPa s, “KRYTOX GPL-102” has a viscosity of 26 mPa s, and “KRYTOX GPL-101” has a viscosity of 12 mPa s.

The thickness of the resinous membrane is preferably from 12 μm to 100 μm, more preferably from 15 μm to 40 μm.

In step (v), the first surface of the resinous membrane is immersed to be wetted in a solvent that can dissolve PFPE in the impregnated resinous membrane but does not dissolve PFA.

Here, the “solvent that dissolves PFPE” can be, for example, a solvent that dissolves 10 g or more of PFPE per 100 g of solvent at 25° C. Meanwhile, the “solvent that does not dissolve PFA” can be a solvent that dissolves 1 g or less of PFA per 100 g of solvent at 25° C.

Examples of such solvents include hydrofluoroethers. As the hydrofluoroether, for example, one commercially available as “NoveC7600” (trade name, manufactured by 3M Co.) can be used.

In addition, in step (v), when removing PFPE from the impregnated resinous membrane, application of ultrasonic waves or heating of a fluorine solvent is effective in order to remove PFPE more efficiently.

### EXAMPLES

Preferred embodiments of the present disclosure are described in the following Examples, but the present disclosure is not limited to or by the following embodiments.

In the Examples, resinous membranes were produced using the following PFA resins and perfluoropolyethers.

(PFA)
PFA-1: “959HP-Plus” (trade name, manufactured by Mitsui Chemours Fluoro Products Co., Ltd.)
PFA-2: “451HP-J” (trade name, manufactured by Mitsui Chemours Fluoro Products Co., Ltd.) (Perfluoropolyether)
PFPE-1: “KRYTOX GPL104” (trade name, manufactured by The Chemours Company, 111 mPa·s (40° C.))
PFPE-2: “KRYTOX GPL105” (trade name, manufactured by The Chemours Company, 301 mPa·s (40° C.))

### Example 1

(Production of PFA Sheet)

A PFA sheet with a thickness of 30 μm was produced by injection molding of PFA-1. An adhesive was applied to the entire surface of one side of the PFA sheet, and the surface was masked by adhering a protective member.

(Impregnation Step)

A perfluoropolyether (PFPE-1) was placed in a borosilicate glass beaker. A heating wire covered with insulation was wound around the entire beaker, and PFPE was heated to a temperature of 310° C. A PFA sheet masked on one surface was attached to a dipping device and immersed in heated PFPE so that the entire unmasked surface of the PFA sheet was in contact with PFPE. After 1 min, the PFA sheet was removed from the beaker to obtain a PFPE-comprising PFA sheet.

(Measurement of PFPE Content in Resinous Membrane)

From the PFPE-comprising PFA sheet produced by the above impregnation step, the protective member masking one side of the PFA sheet was removed by dissolving the adhesive. The PFPE-comprising PFA sheet thus obtained was analyzed using a thermogravimetric analyzer (TGA). Then, the content ratio (% by mass) of PFPE with respect to the PFPE-comprising PFA sheet was calculated under the following measurement conditions.
Apparatus: TGA851 (manufactured by Mettler Toledo)
Atmosphere: in the air
Temperature: 425° C.

In the measurement time−weight loss rate profile obtained by the thermogravimetric analysis, a linear least-squares approximation formula was obtained from a region with a constant slope where only PFA was decreasing, the intercept of the linear least-squares approximation formula was taken as a PFA amount (% by mass), and calculation was performed by the following formula: PFPE content (% by mass)=100−PFA amount.

(Pore Formation Step)

The PFPE-comprising PFA sheet produced by the above impregnation step was immersed in a beaker containing a fluorine solvent (trade name: NOVEC 7300, manufactured by 3M Co.) so that the unmasked side of the PFA sheet was completely immersed in the fluorine solvent. This beaker was placed in a water tank of an ultrasonic wave applicator (trade name: BRANSONIC (model 2510J-DTH); manufactured by Emerson Japan, Ltd.), and ultrasonic waves were applied for 60 min.

After that, the PFA sheet was taken out from the beaker, allowed to stand in an environment at a temperature of 25° C. for 60 min, and dried. In this way, PFPE present on the surface and inside of the PFPE-comprising PFA sheet was removed. Furthermore, the protective member masking one side of the PFA sheet was removed by dissolving the adhesive to obtain a resinous membrane according to the present example.

The obtained resinous membrane had a white appearance visually, and it was confirmed that pores were formed in the resinous membrane. Two sets of this resinous membrane were produced. One set was subjected to the following water pressure resistance and moisture permeability tests. The other set was subjected to the following SEM image analysis (calculation of P1, P2 and surface opening diameter).

<Evaluation>

Methods for evaluating the resinous membrane are shown below.

<Water Pressure Resistance>

Five evaluation samples were prepared for the water pressure resistance test, and the average value of water pressure resistance (kPa) measured in accordance with the provisions of JIS L 1092:2009 “Testing Method B for Water Resistance (High Water Pressure Method)” was taken as the water pressure resistance of the resinous membrane.

Specifically, the evaluation sample was attached to a water resistance tester (trade name: WP-1000K; manufactured by Daiei Kagaku Seiki Mfg. Co., Ltd.) so that water was in contact with one surface of the sample. Then, the water pressure was increased at a rate of 100 kPa per minute, and the water pressure was measured when water came out from three locations on the opposite side of the evaluation sample. An arithmetic mean value of five samples was obtained.

This evaluation was performed on the surfaces on both sides of the resinous membrane to be measured, and when the water pressure resistance values differed on both sides, the higher value was adopted. The surface to which the value was given was considered as the first surface of the resinous membrane.

<Moisture Permeability>

Moisture permeability was determined according to JIS Z 0208: 1976 “Testing Methods for Determination of the Moisture Permeability of Moisture-Proof Packaging Materials (Cup Method)”. Specifically, calcium chloride was placed in a moisture-permeable cup made of aluminum material.

The resinous membrane was attached to the cup base so that one side of the resinous membrane faced the moisture-permeable cup side, and the periphery was sealed with a sealing wax to produce a test specimen. The test specimen was placed in a constant temperature and humidity chamber (PR-2KP, manufactured by Espec Corp.) with an atmosphere of a relative humidity of 90% at 40° C., and the mass increase of the test specimen after 24 h was measured on an electronic balance (AT201, manufactured by METTLER TOLEDO). The water vapor permeability was calculated by converting per 1 m² of area.

In addition, the moisture permeability of water vapor was calculated in the same manner as above, except that the other side of the resinous membrane was attached to the cup base so as to face the moisture-permeable cup side. When there was a difference in the obtained values, the value with the larger permeability was adopted. Three samples were subjected to the present test, and the arithmetic mean value thereof was taken as the moisture permeability in the present evaluation.

<Pore Ratio: Calculation of P1 and P2>

(Measurement of P1)

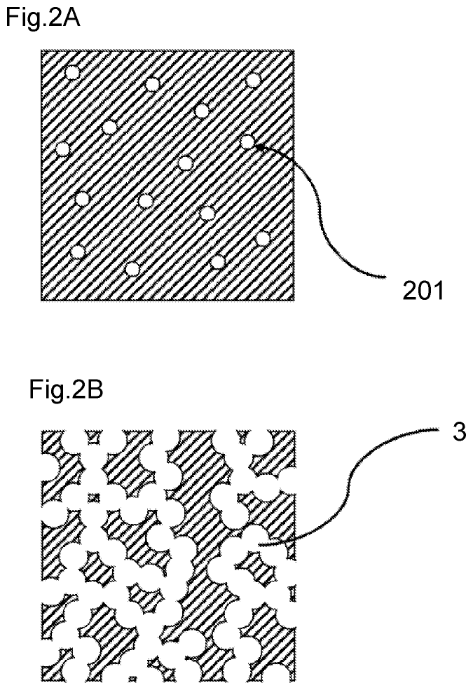

P1 was calculated as follows. As described above, the surface for which a high water pressure resistance value was obtained was considered as the first surface of the resinous membrane. The first surface of the resinous membrane was observed with a scanning electron microscope, and an SEM image (magnification: 10,000 times) of an area of 8 μm length and 11 μm width on the first surface was acquired. The resolution of the SEM image was 717 pixels vertically and 986 pixels horizontally so that individual openings in the first surface could be observed in the SEM image. A schematic diagram of the obtained SEM image is shown in FIG. 2A. In FIGS. 2A and 2B, reference numeral 201 indicates an opening on the first surface of pores 3 formed in the resinous membrane.

Next, the acquired SEM image was converted to an 8-bit grayscale image using image processing software (trade name: Image-J, manufactured by the National Institutes of Health (NIH), USA). After applying a median filter to the obtained grayscale image, binarization processing was further performed using the above image processing software to obtain a binarized image. For the binarization process, Yen's method was used to discriminate between a portion corresponding to the opening and the portion corresponding to the PFA in the SEM image.

The ratio of the number of pixels in the portion corresponding to the opening in the obtained binarized image to the number of pixels in the entire image was calculated. Here, the observation areas were set at arbitrary 10 locations on the first surface of the resinous membrane, and the arithmetic average value of the ratios calculated from each observation area was taken as P1. The 10 observation areas were set to positions such that the observation areas did not overlap each other.

(Average Opening Diameter on the First Surface)

The area of the portion corresponding to the opening in the binarized image created when calculating P1 was approximated by a perfect circle having the same area, and the diameter of the perfect circle (hereinafter referred to as equivalent circle diameter) was averaged to calculate the average opening diameter. Here, the arithmetic average value of the equivalent circle diameters of the openings obtained from ten binarized images was taken as the average opening diameter on the first surface.

(Measurement of P2)

P2 was calculated as follows. Using a cryomicrotome (manufactured by Leica Microsystems, Inc.), three cross-sectional samples showing a cross-section including the entire thickness of the resinous membrane were cut out from three portions of the resinous membrane. The cross section of each of the obtained cross-sectional samples was observed with a scanning electron microscope, and an SEM image (magnification: 10,000 times) of a rectangular observation area of 8 μm length and 11 μm width was acquired.

FIG. 2B shows a schematic diagram of the SEM image obtained with a resolution of 717 pixels vertically and 986 pixels horizontally so that the pores appearing in the cross section could be recognized. The obtained SEM image was binarized using numerical calculation software (trade name: MATLAB; manufactured by The MathWorks, Inc.) to obtain a binarized image. The binarization process used the Otsu's method to discriminate between a portion corresponding to the opening and a portion corresponding to the PFA in the SEM image. The ratio of the number of pixels corresponding to the pores in the binarized image to the number of pixels in the entire image was calculated. The SEM image acquisition positions in the thickness direction of the cross-section of the cross-section sample were three positions defined by (i) to (iii) below.

(i) A position where 1 μm from the first surface side of the cross section to the second surface side opposite to the first surface is the upper end of the observation area, and the long side of the observation area is parallel to the first surface.

(ii) A position where the midpoint between the first surface and the second surface of the cross section coincides with the center of gravity of the observation area, and the long side of the observation area is parallel to the first surface.

(iii) A position where 1 μm from the second surface to the first surface is the lower end of the observation area, and the long side of the observation area is parallel to the second surface.

A total of nine SEM images were thus acquired. The arithmetic mean value of the ratios calculated from each of the nine SEM images was taken as the value of P2 of the resinous membrane.

### Examples 2 to 5

The type of PFA, the thickness of the resinous membrane, the type of PFPE to be impregnated in the impregnation step, and the temperature at the time of contact between PFA and PFPE were set as shown in Table 1-1. Resinous membranes according to Examples 2 to 5 were produced in the same manner as in Example 1, except for these. For each resinous membrane obtained, the PFPE content after the PFPE impregnation step, pore properties, water pressure resistance and moisture permeability were evaluated in the same manner as in Example 1.

### Comparative Example 1

An aqueous dispersion of PFA (trade name: 945HP, manufactured by Mitsui Chemours) was mixed with an acetone solution of a tetrafluoroethylene-vinylidene fluoride copolymer resin (trade name: NEOFLON VDF, Daikin Industries) (945HP: NEOFLON VDF=1:1 (mass ratio)), and the mixture was gelled. The solid matter was removed by filtration, dried, then pelletized, and extrusion molded into a sheet having a thickness of 50 μm.

The sheet was then immersed in acetone to dissolve and remove the tetrafluoroethylene-vinylidene fluoride copolymer resin, and a PFA resinous membrane with a uniform porosity was produced. This resinous membrane was evaluated in the same manner as in Example 1 for pore properties, water pressure resistance, and moisture permeability.

### Comparative Example 2

A stainless steel (SUS) sheet was dip-coated with an amorphous fluoropolymer (trade name: TEFLON AF2400, manufactured by The Chemours Company) solution, dried, and peeled off to produce a resinous membrane. Pore properties, water pressure resistance and moisture permeability were evaluated in the same manner as in Example 1.

### Comparative Example 3

As the resinous membrane, a commercially available expanded polytetrafluoroethylene membrane (trade name: POREFLON FP-010-60, manufactured by Sumitomo Electric Fine Polymer, Inc.) was prepared (hereinafter also referred to as “ePTFE-1”). This resinous membrane was evaluated in the same manner as in Example 1 for pore properties, water pressure resistance, and moisture permeability.

### Comparative Example 4

As the resinous membrane, a commercially available expanded polytetrafluoroethylene membrane (trade name: POREFLON FP-045-80, manufactured by Sumitomo Electric Fine Polymer, Inc.) was prepared (hereinafter also referred to as “ePTFE-2”). This resinous membrane was evaluated in the same manner as in Example 1 for pore properties, water pressure resistance, and moisture permeability.

Table 1-2 shows the evaluation results of the resinous membranes produced in Examples 1 to 5 and Comparative Examples 1 to 4.

TABLE 1-1

| | | | | | PFPE | | |
|---|---|---|---|---|---|---|---|
| | | Resin membrane | | | | Temperature at | Content |
| | | | Melting | Thickness | Material | time of contact | (% by |
| | | Material | point (° C.) | (μm) | type | (° C.) | mass) |
| Example | 1 | PFA-1 | 296 | 42 | PFPE-1 | 310 | 41 |
| | 2 | PFA-1 | 296 | 38 | PFPE-1 | 300 | 26 |
| | 3 | PFA-1 | 296 | 26 | PFPE-2 | 310 | 30 |
| | 4 | PFA-1 | 296 | 36 | PFPE-2 | 295 | 25 |
| | 5 | PFA-2 | 305 | 25 | PFPE-1 | 320 | 27 |
| Comparative | 1 | “945P” | 296 | 50 | — | — | — |
| Example | 2 | “AF2400” | 280 | 20 | — | — | — |
| | 3 | ePTFE-1 | 330 | 60 | — | — | — |
| | 4 | ePTFE-2 | 330 | 80 | — | — | — |

TABLE 1-2

| | | Pore properties | | | | Evaluation results | |
|---|---|---|---|---|---|---|---|
| | | Surface opening | | | | Water pressure | |
| | | diameter | P1 | P2 | | resistance | Moisture permeability |
| | | (nm) | (%) | (%) | P2/P1 | (kPa) | g/m²_day |
| Example | 1 | 120 | 9.7 | 40.0 | 4.1 | 850 | 5277 |
| | 2 | 75 | 6.5 | 27.0 | 4.2 | 900 | 3181 |
| | 3 | 79 | 3.9 | 30.0 | 7.7 | 1050 | 3625 |
| | 4 | 65 | 3.4 | 25.0 | 7.4 | 1200(*) | 1988 |
| | 5 | 95 | 6.0 | 28.0 | 4.7 | 950 | 3382 |
| Comparative | 1 | 300 | 50.0 | 50.0 | 1.0 | 250 | 7488 |
| Example | 2 | 120 | 29.0 | 34.0 | 1.2 | 500 | 4204 |
| | 3 | 100 | 80.0 | 80.0 | 1.0 | 375 | 9192 |
| | 4 | 450 | 80.0 | 80.0 | 1.0 | 200 | 10438 |

*Water pressure when water comes out from one place on the opposite side of the evaluation sample

From the evaluation results of water pressure resistance and moisture permeability shown in Table 1-2, it was found that the resinous membranes according to the present disclosure achieved high moisture permeability and high water pressure resistance at high levels.

According to one aspect of the present disclosure, it is possible to obtain a resinous membrane capable of achieving both high moisture permeability and high water pressure resistance at high levels. According to another aspect of the present disclosure, it is possible to obtain a water-resistant and moisture-permeable membrane capable of achieving both high moisture permeability and high water pressure resistance at high levels.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A resinous membrane comprising a resin containing a tetrafluoroethylene-perfluoroalkyl vinyl ether copolymer,
the resinous membrane having a water pressure resistance of 800 kPa or more, and having a moisture permeability of 1500 g/m²·day or more.

2. The resinous membrane according to claim 1, having pores which open to a first surface of the resinous membrane and are connected to a second surface on an opposite side to the first surface, wherein
when
a first observation area of 8 μm length and 11 μm width is put on the first surface and a ratio of a total area of an opening observed in the first observation area to an area of the first observation area is denoted by P1, and
a second observation area of 8 μm length and 11 μm width is put on a cross section of the resinous membrane in a thickness direction and a ratio of a total area of the pores observed in the second observation area to an area of the second observation area is denoted by P2, P1 and P2 satisfy the following relation:
1.3≤(P2/P1).

3. The resinous membrane according to claim 2, wherein
P1 is from 1.0% to 15.0%, and P2 is from 20.0% to 60.0%.

4. The resinous membrane according to claim 2, wherein an average opening diameter of the opening on the first surface of the resinous membrane is from 1 nm to 200 nm.

5. The resinous membrane according to claim 2, wherein P2/P1 is 20.0 or less.

6. The resinous membrane according to claim 1, wherein the resinous membrane is a single-layer membrane.

7. The resinous membrane according to claim 1, wherein the resinous membrane has a thickness of from 12 μm to 100 μm.

8. The resinous membrane according to claim 1, having a water pressure resistance of 1500 kPa or less, and having a moisture permeability of is 8000 g/m²·day or less.

9. A resinous membrane comprising a resin containing a tetrafluoroethylene-perfluoroalkyl vinyl ether copolymer,
the resinous membrane having pores open to a first surface and connected to a second surface on an opposite side to the first surface, wherein
when
a first observation area of 8 μm length and 11 μm width is put on the first surface and a ratio of a total area of an opening observed in the first observation area to an area of the first observation area is denoted by P1, and
a second observation area of 8 μm length and 11 μm width is put on a cross section of the resinous membrane in a thickness direction and a ratio of a total area of the pores observed in the second observation area to an area of the second observation area is denoted by P2, P1 and P2 satisfy the following relationship:
1.3≤(P2/P1).

10. A water-resistant and moisture-permeable membrane comprising the resinous membrane according to claim 1.
